(19) United States
(12) Patent Application Publication
(10) Pub. No.: US 2007/0254544 A1
(43) Pub. Date: Nov. 1, 2007

(54) Method for disinfecting a non-porous textile fabric and a disinfected, non-porous textile fabric

(75) Inventors: Craig A. Rubin, Franklin, MI (US); Charles G. Hadfield, Berkley, MI (US)

Correspondence Address: BROOKS KUSHMAN P.C., 1000 TOWN CENTER, TWENTY-SECOND FLOOR, SOUTHFIELD, MI, 48075, US

(73) Assignee: Hi-Tex, Inc., West Bloomfield, MI (US)

(21) Appl. No.: 11/411,406

(22) Filed: Apr. 26, 2006

(51) Int. Cl. B32B 27/04; B32B 5/24; B32B 27/12

(52) U.S. Cl. 442/123; 442/394; 442/370

(57) ABSTRACT

According to one embodiment, the invention relates to a method for disinfecting a non-porous textile fabric. The method includes providing a non-porous textile fabric comprising a barrier system having a fluid barrier property. The barrier system blocks the passage of harmful microorganisms through the non-porous textile fabric. The method further includes selecting a disinfectant such that (1) the disinfectant does not substantially diminish the fluid barrier property of the barrier system upon application to the non-porous textile fabric, and (2) kills the harmful microorganisms. The method also includes applying the disinfectant to the non-porous textile fabric to kill the harmful microorganisms residing on the surface of the non-porous textile fabric. In at least one embodiment, the disinfectant includes a quaternary ammonium compound.

### BACKGROUND OF THE INVENTION

1. Field of the Invention

One aspect of the present invention relates to a method for disinfecting a non-porous fabric surface. Another aspect of the present invention relates to a disinfected, non-porous textile fabric.

2. Background Art

Disinfection refers to the destruction of pathogenic and other kinds of microorganisms by physical or chemical means. Disinfectants are chemical substances used to destroy viruses and microbes, i.e. germs, such as bacteria and fungi. Disinfectants are frequently applied to hard surfaces to disinfect the hard surfaces from viruses and microbes residing on the surface. Disinfectants are frequently used on hard surfaces found in hospitals, kitchens and bathrooms. Specific non-limiting examples of hard surfaces include countertops, tubs, tile, floors, walls, sinks and mirrors.

Effective disinfectants provide a relatively high level of sterilization, without harming other forms of life, and are inexpensive and non-corrosive to the surface being treated. Unfortunately, disinfectants that provide acceptable sterilization characteristics can be corrosive to the surface being disinfected. For instance, disinfectants are generally known as being corrosive to fabric surfaces that have been treated to impart water resistance properties. In this case, the treatment chemicals are at least partially dissolved by the disinfectant, thereby destroying the water resistance of the treated fabric. Treated fabric manufacturers typically affix warning tags to their products to instruct the consumer not to use disinfectants on the treated fabric.

Phenolic disinfectants are generally known to degrade the hydrostatic resistance of treated fabrics. Although phenolics are commonly used as a household disinfectant, their use with treated fabrics degrades the treatment chemicals. Moreover, other common disinfectants, such as toluene and hypochlorites, have a similar negative effect on the integrity of treated fabrics.

In addition to the corrosive effects of disinfectants on treated fabrics, the treated fabrics themselves add to the challenges to effective disinfecting. Textile fabrics are generally known as porous materials. Therefore, harmful microorganisms can penetrate the fabric surface and become embedded into materials positioned under the fabric surface. For instance, upholstered articles are typically comprised of a foam core at least partially surrounded by a fabric layer. While the microorganisms can migrate into the foam core, the disinfectant is absorbed by the fabric and cannot reach the foam core to kill the pathogen of the microorganisms.

In light of the foregoing, what is needed is a method of providing a disinfectable non-porous textile fabric. What is also needed is a method of selecting a disinfectant that is non-corrosive to non-porous textile fabrics.

### SUMMARY OF THE INVENTION

According to one aspect of the present invention, a method for providing a non-porous textile fabric that is suitable for disinfecting is disclosed. According to another aspect of the present invention, a method for selecting a disinfectant that is non-corrosive to a non-porous textile fabric is disclosed. According to yet another aspect, a disinfected, non-porous textile fabric is disclosed.

According to a first embodiment of the present invention, a method for disinfecting a non-porous textile fabric is disclosed. The method includes providing a non-porous textile fabric comprising a barrier system having a fluid barrier property capable of blocking the passage of harmful microorganisms through the non-porous textile fabric; selecting a disinfectant such that (i) the disinfectant does not substantially diminish the fluid barrier property of the barrier system upon application to the non-porous textile fabric, and (ii) kills the harmful microorganisms; and applying the disinfectant to the non-porous textile fabric to kill the harmful microorganisms residing on the surface of the non-porous textile fabric. In at least one embodiment, the disinfectant includes a quaternary ammonium compound.

According to a second embodiment of the present invention, a method for disinfecting a non-porous textile fabric is disclosed. The method includes providing a non-porous textile fabric comprising a barrier system having a fluid barrier property capable of blocking the passage of harmful microorganisms through the non-porous textile fabric; and selecting a disinfectant such that (i) the disinfectant does not substantially diminish the fluid barrier property of the barrier system upon application to the non-porous textile fabric, and (ii) kills the harmful microorganisms. In at least one embodiment, the disinfectant includes a quaternary ammonium compound.

According to a third embodiment of the present invention, a disinfectable, non-porous textile fabric is disclosed. The fabric includes a textile fabric having a first side and a second side; and a barrier system having a fluid barrier property capable of blocking the passage of harmful microorganisms through the disinfectable, non-porous textile fabric.

These and other aspects of the present invention will be better understood in view of the following detailed description of the invention.

### DETAILED DESCRIPTION OF THE PREFERRED EMBODIMENT(S)

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a single material, compound or constituent or a group or class of materials, compounds or constituents as suitable for a given purpose in connection with the present invention implies that mixtures of any two or more single materials, compounds or constituents and/or groups or classes of materials, compounds or constituents are also suitable. Also, unless expressly stated to the contrary, percent, “parts of,” and ratio values are by weight. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

In at least one embodiment, a method for disinfecting a non-porous textile fabric is disclosed. The method includes providing a non-porous textile fabric comprising a barrier system having a fluid barrier property. The barrier system blocks the passage of harmful microorganisms through the non-porous textile fabric. The method further includes selecting a disinfectant such that (1) the disinfectant does not substantially diminish the fluid barrier property of the barrier system upon application to the non-porous textile fabric, and (2) kills the harmful microorganisms. The method also includes applying the disinfectant to the non-porous textile fabric to kill the harmful microorganisms residing on the surface of the non-porous textile fabric.

In at least one embodiment, the textile fabric is a non-porous textile fabric. The term “non-porous” as used herein means essentially impermeable to liquids, such as water. A non-porous textile fabric has a considerable level of hydrostatic resistance. For example, a non-porous textile fabric can support a considerable column of water without the water penetrating through the fabric. A non-porous textile fabric may include a barrier system to provide this fluid barrier property.

A Suter rating test can be employed to measure the level of hydrostatic resistance, i.e. the height of the column of water at which water begins to penetrate the textile fabric. According to one general description, a Suter machine used to obtain a Suter rating includes a surface having an opening. The sample, e.g. textile fabric, is placed on the surface and over the opening. A glass column is situated above the opening and the sample. A column of water is applied through the glass column and to the sample portion situated above the opening. The height of the water is increased. At a certain point, the water pressure associated with the water column is sufficient to penetrate the test sample, thereby decreasing the water height. A measurement is recorded noting the maximum height of the water in the column during the test. In at least one embodiment, this height can be measured in centimeters and the glass column can have a one-inch diameter. In at least one embodiment, a Suter rating of 100 centimeters or higher is required to pass the Suter test. In at least one embodiment, the Suter rating can be determined by reference to AATCC Test Method 127-1989 Water Resistance: Hydrostatic Pressure Test.

In at least one embodiment, a textile fabric is considered “non-porous” if it has a fluid barrier property, e.g. a Suter rating comparable to a traditionally non-porous material, such as nylon fabric. A treated textile fabric, available from Hi-Tex, Inc. of West Bloomfield, Mich., known as CRYPTON™ textile fabric is a non-porous textile fabric. CRYPTON™ textile fabrics include a barrier system having a fluid barrier property. Examples of CRYPTON™ textile fabrics were disclosed in U.S. Pat. Nos. 5,565,265, 6024,823, 6,165,920, 6,207,250, 6,251,210, 6,492,001, 6,541,138 and 6,884,491, which are hereby incorporated by reference.

One process that can be used to produce CRYPTON™ textile fabric includes topically coating the untreated textile fabric with a first, relatively low viscosity, aqueous treatment composition comprising an antimicrobial agent for imparting antimicrobial properties and a substantial amount of fluorochemical treatment composition for imparting stain and liquid resistant properties. The topical coating step can be accomplished by continuously dipping the textile fabric in an aqueous treatment composition bath. After passing through the bath, the fabric is dried and cured, and then a relatively high viscosity treatment composition comprising a thermoplastic polymer material is knife-coated on the backside of the fabric, which is then dried and cured again, to impart the liquid repellant and non-porous surface properties.

Example 1 confirms that CRYPTON™ textile fabrics have a non-porous characteristic comparable to nylon fabrics.

### EXAMPLE 1

Twelve (12) vinyl fabric samples were chosen from five (5) different vinyl fabric manufacturers. Each vinyl fabric sample was cut into four (4) foot by six (6) foot rectangular piece since this size substantially covers the open plate surface of the Suter machine. Six (6) CRYPTON™ textile fabric samples were also chosen and cut into similar rectangular test pieces. Suter tests were performed on each sample piece. The results of the tests are reproduced in Table 1 and Table 2. Table 1 includes the commercial product name, the manufacturer, the sample weight in ounces per square yard (osy) and Suter rating in centimeters (cm) for each vinyl fabric sample. Table 2 includes the commercial product name, sample weight (osy) and Suter rating (cm) for each CRYPTON™ textile fabric. It should be appreciated that the upper bound of the scale for the Suter machine utilized for this test was 130 cm. Therefore, if the sample exhibited strong hydrostatic resistance at 130 cm, the symbol “+” was added to denote that the Suter rating exceeds 130 cm.

TABLE 1

| Commerical | | | Suter Rating |
|---|---|---|---|
| Product Name | Manufacturer | Weight (osy) | (cm) |
| All American | Uniroyal | 20.52 | 130+ |
| Spirit | Uniroyal | 25.25 | 130+ |
| Duration | Morbern | 20.96 | 130+ |
| Colorguard | Gencor | 24.99 | 130+ |
| Ultrasoftouch | Pioneer | 20.56 | 130+ |
| Dolphin | Morbern | 18.52 | 130+ |
| Ambassador | Morbern | 22.42 | 130+ |
| Patriot Plus | Spradling | 23.00 | 130+ |
| Rogue II | Uniroyal | 22.84 | 130+ |
| Medallion | Morbern | 22.06 | 130+ |
| Mayfair | Spradling | 21.66 | 130+ |
| Oxen | Uniroyal | 17.72 | 130+ |

TABLE 2

| CRYPTON ™ Textile | | Suter Rating |
|---|---|---|
| Fabric | Weight (osy) | (cm) |
| Suede | 9.8 | 120 |
| Printed Crepe | 8.3 | 130+ |
| Fusion | 8.5 | 130+ |
| Jacquard | 9.4 | 130+ |
| Metro | 7.8 | 130+ |
| Smart Suede | 8.0 | 130+ |

Vinyl is considered to be a non-porous material, exhibiting Suter ratings of 100+. The test results demonstrate that CRYPTON™ textile fabrics exhibit Suter ratings, i.e. 100+, consistent with the ratings of non-porous materials. In other embodiments, a textile fabric is considered non-porous if it has a Suter rating of 120 or above.

In at least one embodiment, a disinfectant is selected such that the disinfectant does not substantially diminish the fluid barrier property of the barrier system upon application to the non-porous textile fabric to an extent that the non-porous textile fabric no longer has a Suter rating which is considered non-porous. Such disinfectants do not substantially diminish the Suter rating of the non-porous textile fabric upon one or more applications of the disinfectant to the non-porous textile fabric. While not wanting to be bound to any particular theory, it is believed that certain disinfectants dissolve one or more of the components of the barrier system, thereby corroding the barrier system such that it no longer has the fluid barrier property, i.e. the textile fabric has a Suter rating which is considered porous.

Suitable disinfectants include liquid disinfectants comprised of one or more quaternary ammonium compounds having a formula [R₁R₂R₃R₄N]⁺X⁻, wherein R₁ and R₂ are selected from the group consisting of substituted or unsubstituted alkyl or alkylene groups containing from 8 to 20 carbon atoms and benzyl, R₃ and R₄ are selected from the group consisting of substituted or unsubstituted alkyl or alkylene groups containing from 1 to 4 carbon atoms and benzyl, and X is a halogen atom, sulfate group or nitrate group. Non-limiting examples of suitable quaternary disinfectants include dioctyl, octyldecyl and didecyl dimethyl ammonium chloride, N-alkyl (C₁₂ to C₁₈) dimethyl benzyl ammonium chloride, and N-alkyl (C₁₂ to C₁₈) dimethyl ethylbenzyl ammonium chloride and mixtures thereof.

In at least one embodiment, the liquid disinfectant has a phenol coefficient in the range of 6 to 18 and a pH of 7.5 to 10.5. The liquid disinfectant can be prepared in a concentrated and/or “ready to use” formulation. The liquid disinfectant can also include one or more inert ingredients, for example, fragrances, detergents, surfactants, fabric fresheners and/or anionic hydrates. The inert ingredients can be selected to obtain a pH within the above-identified range, which in some embodiments, has been found to not have a substantial corrosive effect on the barrier system. While not wanting to be bound to any particular theory, pHs that exceed 10.5 may impart a soapy residue on the surface of the treated fabric, thereby attracting dirt and germ molecules. Therefore, in certain embodiments, the above-identified pH range is suggested to avoid this possibility.

It should be appreciated that the disinfectant can comprise a number of different quaternary ammonium compounds. One such example is Maquat 86, available from Mason Chemical Company of Arlington Heights, Ill. Maquat 86 includes the following ingredients, by weight percentage:

ACTIVE INGREDIENTS

| | |
|---|---|
| Octyl Decyl Dimethyl Ammonium Chloride | 0.026% |
| Didecyl Dimethyl Ammonium Chloride | 0.013% |
| Dioctyl Dimethyl Ammonium Chloride | 0.013% |
| Alkyl Dimethyl Benzyl Ammonium Chloride | 0.034% |

| | |
|---|---|
| INERT INGREDIENTS | 99.914% |
| TOTAL | 100.000% |

Maquat 86 has a phenol coefficient of 8.5.

In at least one embodiment, a disinfectant is selected based on the disinfectant's ability to kill harmful microorganisms residing on the surface of the non-porous textile fabric. Suitable disinfectants have the ability to eliminate one or more types of harmful microorganisms. Suitable disinfectants include liquid disinfectants comprised of one or more quaternary ammonium compounds, as described above. A specific non-limiting example is Maquat 86. In at least one embodiment, the disinfectant also has the ability to inhibit the growth of harmful microorganisms on the non-porous textile fabric.

In at least one embodiment, the selected disinfectant is suitable for use on upholstery comprised of a foam core at least partially surrounded by a non-porous textile fabric. Since harmful microorganisms cannot penetrate the non-porous surface, they cannot migrate to the foam core layer. Instead, the harmful microorganisms are trapped on the non-porous surface, where they can be killed by the disinfectant.

Non-limiting examples of harmful microorganism include germs, viruses and/or fungicides. Non-limiting examples of germs include E coli, salmonella, staphylococcus, streptococcus, and staphylococcus aureus. Non-limiting examples of viruses include avian influenza, canine distemper, parvovirus, hepatitis A, hepatitis B, herpes simplex I, herpes simplex II, HIV, influenza A, influenza Brazil virus, rhinovirus, gastroenteritis, and porcine respiratory and reproductive virus. Non-limiting examples of fungicides include mold and mildew.

In at least one embodiment, a suitable disinfectant is applied to the non-porous textile fabric to kill harmful microorganisms residing on the surface of the non-porous textile fabric. The liquid disinfectant can be applied to the non-porous surface in any suitable manner, such as a cloth, mop or mechanical spray device as to thoroughly wet the non-porous surface. Further, if a mechanical spray device is utilized, the spray distribution can be relatively coarse. In at least one embodiment, the liquid disinfectant is sprayed from 6-8 inches away from the non-porous surface. Once applied to the surface, the liquid disinfectant can be rubbed with a brush, sponge or cloth.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

What is claimed is:

1. A method for disinfecting a non-porous textile fabric, the method comprising:
(a) providing a non-porous textile fabric comprising a barrier system having a fluid barrier property capable of blocking the passage of harmful microorganisms through the non-porous textile fabric;
(b) selecting a disinfectant such that (i) the disinfectant does not substantially diminish the fluid barrier property of the barrier system upon application to the non-porous textile fabric and (ii) kills the harmful microorganisms; and
(c) applying the disinfectant to the non-porous textile fabric to kill the harmful microorganisms residing on the surface of the non-porous textile fabric.

2. The method of claim 1, wherein the fluid barrier property is a Suter rating of 100 or greater using the AATCC Test Method 127-1989 Water Resistance: Hydrostatic Pressure Test.

3. The method of claim 1, wherein the fluid barrier property is a Suter rating of 120 or greater using the AATCC Test Method 127-1989 Water Resistance: Hydrostatic Pressure Test.

4. The method of claim 1, wherein the barrier system comprises a polymeric film applied to at least one side of the fabric.

5. The method of claim 4, wherein step (a) comprises:
(a1) providing an untreated textile fabric having a first side and a second side; and
(a2) securing at least one polymeric film to one side of the fabric.

6. The method of claim 5, wherein step (a) further comprises:
(a3) topically treating the untreated textile fabric with an aqueous primary treatment composition comprising a fluorochemical textile treating agent; and
(a4) drying and curing the topically treated fabric at an elevated temperature to obtain a primarily treated fabric.

7. The method of claim 1, wherein the disinfectant is comprised of at least one quaternary ammonium compound having a formula [R₁R₂R₃R₄N]⁺X⁻,
wherein R₁ and R₂ are selected from the group consisting of substituted or unsubstituted alkyl or alkylene groups containing from 8 to 20 carbon atoms and benzyl,
R₃ and R₄ are selected from the group consisting of substituted or unsubstituted alkyl or alkylene groups containing from 1 to 4 carbon atoms and benzyl, and
X is a halogen atom, sulfate group or nitrate group.

8. The method of claim 7, wherein X is chlorine.

9. The method of claim 8, wherein the disinfectant is comprised of a first quaternary ammonium compound and a second quaternary ammonium compound, wherein the first and second quaternary ammonium compounds being different from one another.

10. The method of claim 9, wherein the first quaternary ammonium compound has an R₁ of an alkyl, R₂ of a benzyl, and R₃ and R₄ of methyl.

11. The method of claim 9, wherein the second quaternary ammonium compound has an R₁ of an octyl, R₂ of a decyl, and R₃ and R₄ of methyl.

12. The method of claim 7, wherein the pH of the at least one quaternary ammonium compound is in the range of 7.5 to 10.5.

13. The method of claim 7, wherein the disinfectant is a liquid disinfectant.

14. The method of claim 7, wherein the disinfectant comprises one or more inert compounds selected from the group consisting of: water, surfactants, detergents, and/or anionic hydrates.

15. The method of claim 1, wherein the harmful microorganisms comprise viruses and bacteria.

16. The method of claim 1, wherein the harmful microorganisms comprise viruses, bacteria, and fungicides.

17. The method of claim 1, wherein the applying step (c) further includes:
(c1) inhibiting the growth of fungicides.

18. The method of claim 13, wherein the applying step (c) is carried out with a mechanical spray device.

19. The method of claim 1, wherein the disinfectant has a phenol coefficient in the range of 6 to 18.

20. The method of claim 1, further comprising:
(d) providing an upholstered article comprised of a foam core at least partially surrounded by the non-porous textile fabric.

21. The method of claim 20, wherein the barrier system inhibits the penetration of the harmful microorganisms into the foam core.

22. A method for disinfecting a non-porous textile fabric, the method comprising:
(a) providing a non-porous textile fabric comprising a barrier system having a fluid barrier property capable of blocking the passage of harmful microorganisms through the non-porous textile fabric; and
(b) selecting a disinfectant such that (i) the disinfectant does not substantially diminish the fluid barrier property of the barrier system upon application to the non-porous textile fabric and (ii) kills the harmful microorganisms.

23. The method of claim 22 wherein the disinfectant is comprised of at least one quaternary ammonium compound having a formula [R₁R₂R₃R₄N]⁺X⁻,
wherein R₁ and R₂ are selected from the group consisting of substituted or unsubstituted alkyl or alkylene groups containing from 8 to 20 carbon atoms and benzyl,
R₃ and R₄ are selected from the group consisting of substituted or unsubstituted alkyl or alkylene groups containing from 1 to 4 carbon atoms and benzyl, and X is a halogen atom, sulfate group or nitrate group.

24. A disinfected, non-porous textile fabric produced by the process of claim 1.

25. The disinfected, non-porous textile fabric of claim 24, wherein the barrier system comprises:
a polymeric film secured to at least one side of the fabric.

26. The disinfected, non-porous textile fabric of claim 25, wherein the barrier system further comprises:
a coating on at least one side of the fabric, the coating comprising the cured product of an aqueous primary treatment composition comprising from 6 to 12 weight percent of a fluorochemical textile treating agent, based on the weight of the primary treatment composition.

27. The disinfected, non-porous textile fabric of claim 25, further comprising an upholstered article comprised of a foam core at least partially surrounded by the textile fabric.
